(19) United States
(12) Patent Application Publication
(10) Pub. No.: US 2001/0006523 A1
(43) Pub. Date: Jul. 5, 2001

(54) Method and system for communication to a host within a private network

(76) Inventor: Peter Kriens, Onsala (SE)

Correspondence Address: Ronald L. Grudziecki, Esq., BURNS, DOANE, SWECKER & MATHIS, L.L.P., P.O. Box 1404, Alexandria, VA, 22313-1404, US

(21) Appl. No.: 09/751,013

(22) Filed: Dec. 29, 2000

(30) Foreign Application Priority Data
Dec. 29, 1999 (SE) 9904841-5

(51) Int. Cl. H04L 12/28

(52) U.S. Cl. 370/401

(57) ABSTRACT

A method and a system for establishing a connection between a first computer of a first computer network and a resource of a second computer network via a third network through a gateway intervening between the second computer network and the third network. A requester issues a request for a connection from the first computer to the resource by specifying a name of the resource. A temporary IP number is returned to the first computer in answer to the request. The temporary IP number is mapped to a tunnel to the gateway. The gateway administrates the handling of data packets such that data packets addressed by the first computer to the temporary IP number, arriving through the tunnel, are routed to the resource and data packets arriving from the resource destined to the first computer, are routed through the tunnel to the first computer.

### FIELD OF THE INVENTION

The present invention relates generally to a method and a system for communicating between different networks, especially from one network to a host within a private network.

### BACKGROUND TO THE INVENTION

The Internet is a collection of networks that can interwork. Clients connected to one network can access resources on other networks because data packets are routed from one network to the other. The Internet Protocol (IP) makes this possible. The same protocol can also be used to create private networks that are not directly connected to the Internet. These networks are called intranets. These intranets can be extended over a large area to remote offices using private lines. They are in a way the same intranet because there is a single authority that controls the network. Instead of private lines, an intranet can also be extended using the public internet as a tunneling medium. Instead of coupling an intranet directly to the Internet, the data traffic for a remote office is encapsulated and encrypted before being forwarded over the internet to the remote office. At the remote office, the reverse is done and the data package is placed in the local network. This is usually called a Virtual Private Network (VPN). For the end users it looks like a single private network, but the public Internet is used to securely transport data traffic between remote places.

In the Internet Protocol (IP) routing decisions are made on addresses. An address in IP is a 32-bit number. On the Internet, every host requires at least one unique number to be able to communicate. This unique number cannot be used by any other host on the Internet. A special official body allocates these IP numbers, and Internet routers all over the world must know how to map these IP numbers to the correct hosts. To simplify the routing and due to some original design choices the 4294967296 possible numbers are running out. For this reason there are a number of number ranges that are reserved which anybody can use privately in e.g. a private intranet. However, IP packets cannot be routed over the Internet with a number within these ranges, and consequently must remain within the private intranet. This creates a problem when users of such an intranet with host numbers in these number ranges want to access the Internet.

There are two basic very close solutions to this problem, one is the use of a firewall and the other is using network address translation (NAT). Using a firewall, all access to the Internet is terminated at a firewall computer that is connected both to the Internet and to the intranet. This firewall then looks at the access from the intranet and acts as a proxy to the Internet using its own public IP number that is valid on the internet. However, a proxy requires a program that knows about the protocol. The other solution using NAT has a computer acting as a gateway between the Internet and the intranet. Every packet directed to the Internet is processed by a program that replaces/translates the address and port of the packet, and keeps a track of on who's behalf this translation is done. If the return packet comes, the address is translated back to the original address. NAT is a very transparent solution but unfortunately has some problems with some protocols, which then requires special measures.

A user does not have to use IP numbers to address a packet. When a user uses a name as an address then a special application, a name server, is used to translate the name into an IP number. On the Internet the Domain Name System (DNS) is used for naming. This is a hierarchical scheme where a DNS server can provide the translation for a domain or it can look up the name via/in another name server. If a DNS server comprises tables for a domain, then it is authoritative for that domain. Each DNS server is registered in a parent DNS server, this is done recursively until the root DNS servers are reached. Private intranets also require special handling of the DNS. A host on the inside of the intranet should not be visible on the outside, i.e. on the Internet, because it has a private number. However, when NAT is used, hosts on the outside of the intranet are required to be present in the local intranet DNS. This is called a split universe DNS.

The real problems start when someone on the Internet wants private access to a host on an intranet with a private numbering scheme, or when two intranets with private numbering schemes want to connect privately. For example, assume that two companies, each with their own private intranet, decide to co-operate on a project and that they therefore want to share a number of resources on their respective intranets. This will cause a number of problems. The intranets cannot directly be routed to each other because the IP numbers used potentially overlap. Most probably the respective DNS of both companies are set-up as split universe DNSs and thus have no knowledge of each other's hosts. The normal forwarding to the internet DNS does not help since the domain of the other company does not expose the internal hosts with private IP numbers. Thus, since the internal hosts cannot see each other, it is impossible to route anything between them.

There have been a number of different solutions put forward. Unfortunately the known solutions either does not work for all protocols or they require complex administration or suffer from both disadvantages. For example, proxying is a solution to the problem. For each service that the companies want to share they have a publicly addressable host that contains a proxy for this service. This proxy does the mapping from the outside to the inside. A disadvantage of proxying is that it requires a significant amount of administration to set them up and then to keep them aligned with the original resources. Another disadvantage is that not all protocols are easy to proxy or have existing proxies. Another solution to the problem is to renumber the intranets so that a non-overlapping address space is created. A single DNS can then be used. However, this is a very complicated and heavy operation making it virtually impossible if the companies only co-operate on a project basis. This solution also requires a significant amount of trust between the parties in question.

A suggestion has also been disclosed in U.S. Pat. No. 5,898,830 to Wesinger, Jr. et al. (Wesinger). The Wesinger patent discloses a method of setting up virtual hosts in firewalls and using name based routing. The solution allegedly provides a full transparency for the users. However, this solution also only forwards hosts and not networks and it also requires quite a bit of administration.

There is thus a need to improve the methods of providing access to one or more hosts of a private intranet from the outside of the intranet with full transparency to users and a simple administration.

### SUMMARY OF THE INVENTION

An object of the invention is to define a method and a system for transparently accessing hosts within a private intranet.

Another object of the invention is to define a method and a system for transparently accessing a host within private intranet by name.

A further object of the invention is to define a method and a system for accessing hosts within a private intranet with minimal administration.

A still further object of the invention is to define a method and a system for accessing hosts within a private intranet with security control and access control administration at the private intranet.

The aforementioned objects are achieved according to the invention by a method and a system for establishing a connection between a first computer of a first computer network and a resource, such as a second computer, of a second computer network via a third network through a gateway, such as a firewall, intervening between the second computer network and the third network. A requester issues a request for a connection from the first computer to the resource by specifying a name of the resource. A temporary IP number is returned to the first computer in answer to the request. The temporary IP number is mapped to a tunnel to the gateway. The gateway administrates the handling of data packets such that data packets addressed by the first computer to the temporary IP number, arriving through the tunnel, are routed to the resource and data packets arriving from the resource destined to the first computer, are routed through the tunnel to the first computer.

The aforementioned objects are also achieved according to the invention by a method of establishing a connection between a first computer of a first computer network and a resource of a second computer network via a third network. The connection is established along a route through an intermediate system having an interface to the first computer network, and through a gateway intervening between the second computer network and the third network. The resource belongs to the domain of the gateway. According to the invention the method comprises a number of steps. A first step configuring the intermediate system with a tunnel from the intermediate system to the gateway. A second step mapping the tunnel with a requester and a domain name of the gateway. A third step wherein the requester issues a request for a connection from the first computer to the resource by specifying a name of the resource. A fourth step receiving the request at the intermediate system via the interface. A fifth step using a rule for matching the name of the resource with the gateway. A sixth step mapping the name of the resource to the tunnel. A seventh step returning a temporary IP number to the first computer in answer to the request. An eighth step mapping the temporary IP number to the name of the resource. A ninth step wherein the gateway administrates the handling of data packets such that data packets addressed by the first computer to the temporary IP number, arriving through the tunnel, are routed to the resource. And a tenth step wherein the gateway administrating the handling of data packets such that data packets arriving from the resource destined to the first computer, are routed through the tunnel to the first computer via the intermediate system. It is to be understood that the steps according to the invention do not indicate any sequential execution, but is merely a manner to distinguish them.

The method can advantageously further comprise the step of transmitting a message with the mapping of the temporary IP number to the gateway by means of the tunnel.

Preferably the step of the gateway administrating the handling of data packets such that data packets addressed by the first computer to the temporary IP number, arriving through the tunnel, are routed to the resource, comprises the substep of directing the intermediate system to translate source addresses of data packets addressed to the temporary IP number to be sent through the tunnel. The step of the gateway administrating the handling of data packets such that data packets addressed by the first computer to the temporary IP number, arriving through the tunnel, are routed to the resource, can comprise the substep of directing the intermediate system to translate destination addresses of data packets addressed to the temporary IP number to be sent through the tunnel, by means of at least a partial DNS function in the intermediate system.

Advantageously the step of the gateway administrating the handling of data packets such that data packets addressed by the first computer to the temporary IP number, arriving through the tunnel, are routed to the resource, can comprise the substep of the gateway translating source addresses of data packets arriving through the tunnel addressed to the temporary IP number and routing these data packets to the resource. The step of the gateway administrating the handling of data packets such that data packets addressed by the first computer to the temporary IP number, arriving through the tunnel, are routed to the resource, can comprise the substep of the gateway translating destination addresses of data packets arriving through the tunnel addressed to the temporary IP number and routing these data packets to the resource. The step of the gateway administrating the handling of data packets such that data packets arriving from the resource destined to the first computer, are routed through the tunnel to the first computer via the intermediate system, can comprise the substep of the gateway translating source and destination addresses of data packets arriving from the resource destined to the first computer, and routing these data packets through the tunnel to the first computer via the intermediate system.

In some versions the step of the gateway administrating the handling of data packets such that data packets arriving from the resource destined to the first computer, are routed through the tunnel to the first computer via the intermediate system, can comprise the substep of directing the intermediate system to translate source and destination addresses of data packets arriving from the resource via the tunnel destined to the first computer.

In some versions the third network is a telecommunications network, in other versions it is the Internet, i.e. a computer network.

Advantageously the rule for matching the name of the resource with the gateway can be based on a mapping, and/or based on a list of hosts, and/or based on a regular or wildcard expression, and/or based on matching a domain name of the name of the resource with the domain name of the gateway.

Preferably the method further comprises the step of authenticating the requester at the first computer for access to the tunnel.

In some versions the name of the resource corresponds to a second computer within the second computer network, the second computer belonging to the domain of the gateway and comprising the resource. Then preferably the gateway administrates the handling of data packets such that data packets addressed by the first computer to the temporary IP number, arriving through the tunnel, are routed to the resource residing on the second computer. Otherwise in other versions the gateway administrates the handling of data packets such that data packets addressed by the first computer to the temporary IP number, arriving through the tunnel, are routed to the resource, the resource residing on a proxy of the second computer. Advantageously the proxy to which the gateway routes data packets addressed by the first computer to the temporary IP number, is in dependence on an identity of the requester.

One or more of the features of the above described different methods according to the invention can be combined in any desired manner, as long as the features are not contradictory.

The aforementioned objects are achieved in accordance with the invention also by a device arranged to establish a connection between a first computer of a first computer network and a resource of a second computer network via a third network. The connection being established along a route through the device having an interface to the first computer network, and through a gateway intervening between the second computer network and the third network. The resource belongs to the domain of the gateway. According to the invention the device comprises a number of means arranged to carry out the invention. A first means arranged to configure a tunnel from the device to the gateway. A second means arranged to map the tunnel with a requester and a domain name of the gateway. A third means arranged to receive a request, issued by the requester, via the interface for a connection from the first computer to the resource by specifying a name of the resource. A fourth means arranged to use a rule for matching the name of the resource with the gateway. A fifth means arranged to map the name of the resource to the tunnel. A sixth means arranged to return a temporary IP number to the first computer in answer to the request. A seventh means arranged to map the temporary IP number to the name of the resource. An eighth means arranged to cooperate with the gateway administrating the handling of data packets such that data packets addressed by the first computer to the temporary IP number, arriving through the tunnel at the gateway, are routed to the resource. A ninth means arranged to cooperate with the gateway administrating the handling of data packets such that data packets arriving from the resource destined to the first computer, are at the gateway routed through the tunnel to the first computer via the device.

Different embodiments of the device according to the invention can be reached according to additional features mentioned above in connection with the description of the method according to the invention. The features of the above described different embodiments of a device according to the invention can be combined in any desired manner, as long as no conflict occurs.

By providing a device and a method for accessing one or more hosts within a private intranet, a plurality of advantages over prior art systems are obtained. According to the invention a route process/connection is made within a requesters network, which could also be a private intranet. Complete transparency is achieved; there is no restriction as to what protocol is used. The requester/user does not have to have any understanding of the set-up, such as the use of special ports or hosts and other network issues. The routing is name based; a requester/user requests access to a name of a host and will get an IP number in return to be used for access to the requested host. A requester is totally unaware that the request was intercepted and a route was set-up to respond to the IP number that was returned to the requester. All authentication and security issues such as access control can be handled by the private intranet to which access is desired. All the set-up at the requester's side that is required is some means of intercepting DNS requests before they are transferred to the internet. This means can, for example, be located in a gateway to the internet or at some other point logically before the gateway. This intercept means will have one or more tunnels configured to one or more private intranets and will determine if a DNS request is for one of the private intranets or not. If it determines that the DNS request is for one of the private intranets then a route process is set-up with an arbitrary but for the requester valid IP number and a mapping to the corresponding tunnel is made. All access control can be handled at the other end of the tunnel, but in some embodiments some authentication and security is handled by the intercept means. Preferably all address translation is also done at the private intranet side of the tunnel, but in some embodiments at least some of the address translations can be handled directly by the intercept means, preferably under complete control of the private intranet side of the tunnel. Further advantages and variations of the invention will become apparent from the following.

### DESCRIPTION OF THE FIGURES

The invention will now be described in more detail for explanatory, and in no sense limiting, purposes, with reference to the following figures, in which

FIG. 1 shows a diagram of communication situation to which the invention is suitable,

FIG. 2 shows a diagram of an implementation of the invention,

FIG. 3 shows a flow chart of an example of an intermediate system processing,

FIG. 4 shows a flow chart of an example of a firewall/gateway processing when receiving from a tunnel,

FIG. 5 shows a flow chart of an example of a firewall/gateway processing when transferring a data packet from a second computer to a first computer.

### DESCRIPTION OF PREFERRED EMBODIMENTS

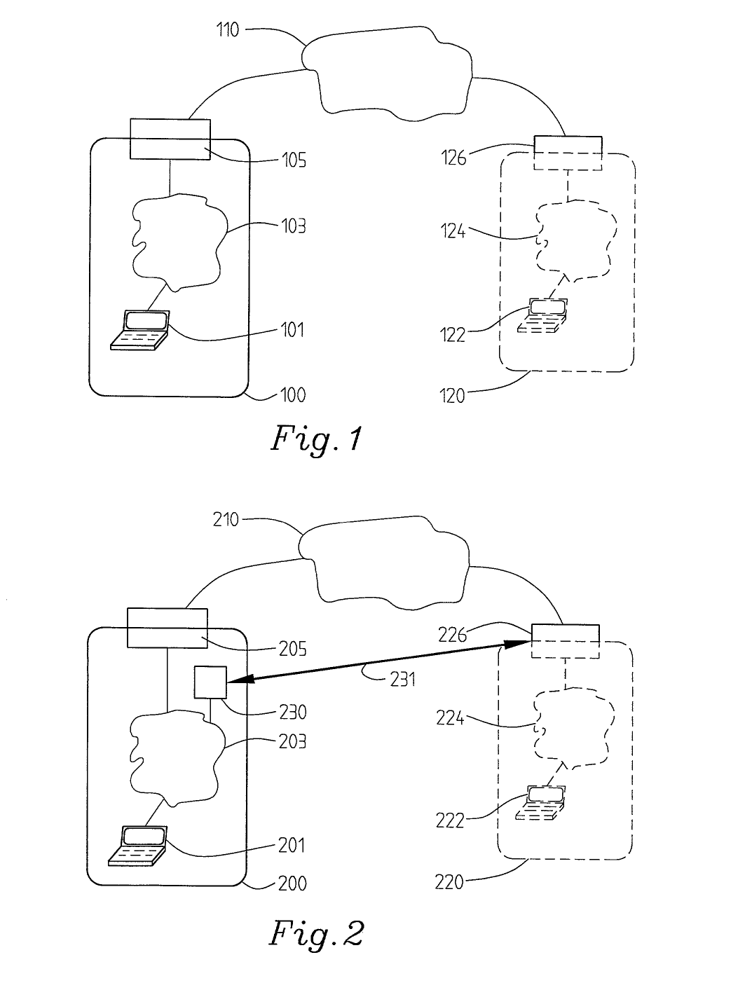

In order to clarify the system according to the invention, some examples of its use will now be described in connection with FIGS. 1 to 5.

FIG. 1 shows a diagram of a communication situation to which the invention is suitable. A user/requestor which is situated at a first computer 101 connected to a first computer network 103, which network can comprise several computer networks, within a first domain 100, which can be open or private, desires to communicate/gain access to a second computer 122, a destination host, connected to a second computer network 124, which network can also comprise several networks, which in turn is within a second domain 120 which is private. A private domain is a domain which uses a private numbering scheme, i.e. hosts within the domain are not visible from the outside and can thus have the same number as a host on the internet. The first computer 101 and the second computer 122 are interconnected via, for example, an internet 110, a third computer network, a network, which will most likely comprise many networks, by means of a gateway/firewall 105 between the first computer network 103 and the third computer network 110, and a firewall/gateway 126 between the second computer network 124 and the third computer network 110. Other types of interconnections between the gateway/firewall 105 of the first computer network and the firewall/gateway 126 of the second computer network 124 are possible according to the invention. However, any direct ways of ordinary connection between the first computer 101 and the second computer 122 is not possible. The second computer 122 is not visible to the first computer 101 or to an internet 110, and if it is not visible then it is not ordinarily possible to route data packages from the first computer 101 to the second computer 122. Several known, less suitable, solutions to this situation have been discussed previously.

FIG. 2 shows a diagram of an implementation of the invention. The set-up is the same as in FIG. 1 with a first computer 201, with a user/requestor, connected to a first computer network 203, which can comprise several computer networks, which in turn is connected to a gateway/firewall 205, all 201, 203, 205 of a first domain 200 which can be open or private. The gateway/firewall 205 is connected between the first computer network 203 and a third computer network 210. The third computer network 210, for example the Internet, will most likely comprise many networks. There is also a second computer 222, a desired destination, which is connected to a second computer network 224, which can comprise several networks, which in turn is connected to a firewall/gateway 226, all of a second domain 220 which is a private domain. The firewall/gateway 226 is connected between the third computer network 210 and the second computer network 224.

According to the invention there is also an intermediate system 230, an intercept means, connected somewhere into the first computer network 203. The intermediate system can be placed anywhere in the first domain 200, as long as it can intercept any DNS request from the first computer 201 before the request reaches the third computer network 210. To give a few examples, the intermediate system 230 can be a process running on the gateway/firewall 205, an intelligent connection box logically connected between the first computer 201 and the gateway/firewall 205, or even a process running on the first computer 201. The intermediate system 230 is preferably implemented as close as possible to, if not within, the gateway/firewall 205 to enable as many users/computers in the first domain 200 to have access to it, and thus have the possibilities of the invention. The intermediate system 230 will configure at least one tunnel 231 from the intermediate system to the firewall/gateway 226 of the second domain 220. A tunnel is a logical network connection between two processes, encapsulating the traffic during transport. Traffic over such a connection is traditionally encrypted to prevent eavesdropping. The tunnel or tunnels are preferably authenticated at regular, or irregular, intervals.

The intermediate system 230 will intercept DNS requests at least from the user or users and associate connection points/connected computers for which the intermediate system is set-up, in this example the first computer 201. The intermediate system must at least intercept DNS requests from the first computer 201 before the requests leave the domain 200. A user wanting a permitted access from the first computer 201 to the second computer 222 requests this by naming the second computer 222. The DNS request will then be intercepted by the intermediate system 230 which will determine if the requested name has any association with any tunnel 231 that is previously set-up. The determination can be based on a mapping, a list of hosts, or a regular or wildcard expression. In a preferred method the intermediate system 230 will try to match a domain name suffix of the second domain 220 to a domain name suffix of the DNS request for a match to the tunnel 231 of the example. As can be seen, the intermediate system does not have to be set-up with any details as to exactly which host or hosts are requested for within the second domain 220. If there is a match the intermediate system will set-up a route to the second domain 220 via a tunnel 231 in view of the match, in this case the described tunnel 231. An IP number, a temporary random IP number, will be generated/made and associated to the route. The generated/given temporary random IP number must at least be valid within the first domain 200 so that communication addressed to that temporary random IP number will be correctly routed to the associated tunnel 231 of the intermediate system 230. The first computer 201 will get the temporary random IP number back as an answer to its DNS request and then use this temporary random IP number for all communication to the second computer 222, at least during this session. The communication will end up at the route interface, which in turn will send it down the tunnel for correct routing to the desired destination, the second computer 222. The temporary random IP number is mapped to the complete name of the DNS request and sent as a message to the gateway/firewall 226 at the other end of the tunnel. The gateway/firewall 226 at the other end of the tunnel 231 will deal with all the details of routing packages to and from the correct desired host, in this case the second computer 222. Return communications will either have the correct destination, the first computer 201, when they emerge from the tunnel 231, or there has been some address translation in the intermediate system 230, governed by the gateway/firewall 226 of the second domain 220, in which case the intermediate system 230 will retranslate the communication so that it will be routed correctly within the first domain 200 to the first computer 201.

For an even better understanding of the invention, it will be explained in relation to flow diagrams of a specific implementation of the invention. Flow diagrams describe something as a string of events, one after another. The different processes according to the invention are mostly independent event-driven processes. The major difference is that the processes of the invention might not appear in the order described below, but it is believed that the flow diagrams can however provide an easier understanding of the invention.

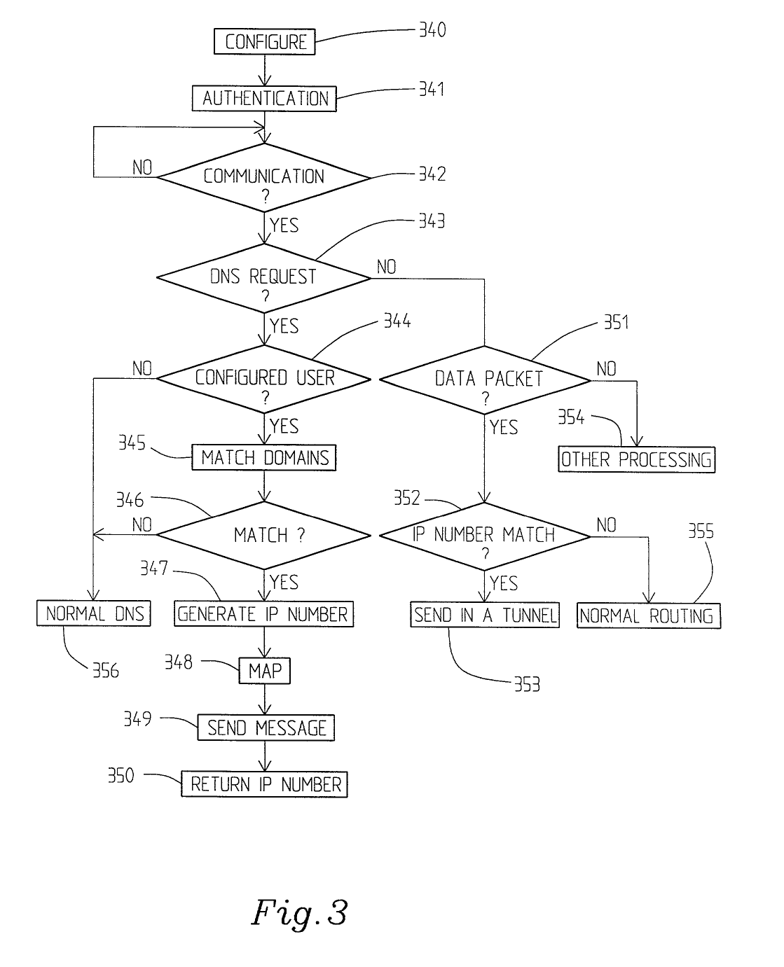

FIG. 3 shows a flow chart of an example of the processes of an intermediate system according to one specific implementation of the invention. In a first step 340 one or more predetermined tunnels are configured and tables/mappings are generated/set-up. A table can, for example, be set-up in a matrix where each line comprises; a user (optionally), a source IP number, a destination domain (e.g. *.ericsson.se), access time or times to the destination domain (optionally), a tunnel to the destination domain. The amount of information comprised in a table and the manner it is stored and mutually associated will vary in dependence of an implementation in question. A table/mapping can preferably be dynamically updated, i.e. information/entries added or deleted from for example a destination domain. In a second step 341 after the first step 340, authentication of the configured tunnel(s) and of configured users/requesters is done, for example, from which source IP number(s), e.g. the first computer, when, and to which domains access is allowed. In a third step 342 after the second step 341 it is determined if there is any communication to intercept or not, if there is none then it simply returns to itself. If there is some communication to intercept, the procedure continues with a fourth step 343 after the third step 342. The fourth step 343 determines if the communication was a DNS request or not. If the communication was determined to be a DNS request, then the procedure continues with a fifth step 344 after the fourth step 343. The fifth step 344 determines if the DNS request is from a configured user, e.g. the first computer, or not. If the DNS request is determined to have originated from a configured user then the procedure continues with a sixth step 345 after the fifth step 344. The sixth step 345 tries to match domains, in the configured user's map/table, with the domain of the DNS request. Thereafter the procedure continues with a seventh step 346 after the sixth step 345. The seventh step 346 determines if there is a match or not. If there is a match, then the procedure continues with an eighth step 347 after the seventh step 346. The eighth step 347 retrieves the entries of the user's map/table which correspond to the match of the seventh step 346 and also generates a temporary IP number, a temporary random IP number, which is a valid IP number in view of the place of the intermediate system. The intermediate system dynamically allocates a temporary IP number. Thereafter the procedure continues with a ninth step 348 after the eighth step 347. The ninth step 348 maps the temporary random IP number to a tunnel according to the retrieved entries in the user's map/table. Thereafter the procedure continues with a tenth step 349 after the ninth step 348. The tenth step 349 will send a message through the tunnel with a mapping of the temporary random IP number with the complete DNS request, i.e. the complete name of the desired destination, e.g. the second computer. Thereafter the procedure continues with an eleventh step 350 after the tenth step 349. The eleventh step 350 returns the temporary random IP number to the requester, e.g. the first computer, in answer to the DNS request.

If in the fourth step 343 it was determined that it was not a DNS request, then the procedure continues with a twelfth step 351 after the fourth step 343. The twelfth step determines if the communication is a data packet or not. If it is determined to be a data packet then the procedure continues with a thirteenth step 352 after the twelfth step 351. The thirteenth step 352 determines if the destination IP number of the data packet matches with any temporary random IP number which is mapped with the source IP number of the data packet. If there is a match, then the procedure continues with a fourteenth step 353 after the thirteenth step 352. The fourteenth step 353 sends the data packet in a tunnel according to the match and corresponding mapping/table entry. If it was determined in the twelfth step 351 that it was not a data packet, then the procedure continues with a fifteenth step 354 after the twelfth step 351. The fifteenth step 354 will ensure that the communication gets attention by means of some other processing. If it was determined in the thirteenth step 352 that there was no match, then the procedure continues with a sixteenth step 355 after the thirteenth step 352. The sixteenth step 355 provides normal routing of the data packet. If it was determined in the fifth step 344 that the DNS request was not from a configured user or if it was determined in the seventh step 346 that there is no match in the users domain name table, then the procedure continues with a seventeenth step 356 after the fifth step 344 or after the seventh step 346. The seventeenth step 356 provides a normal DNS request processing.

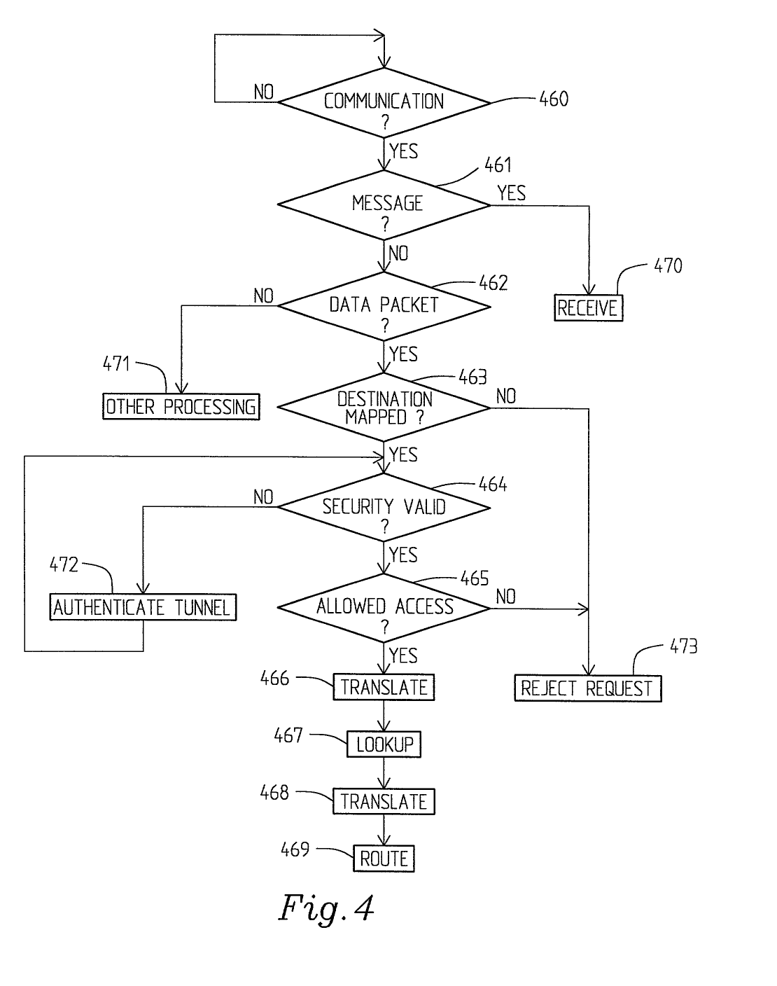

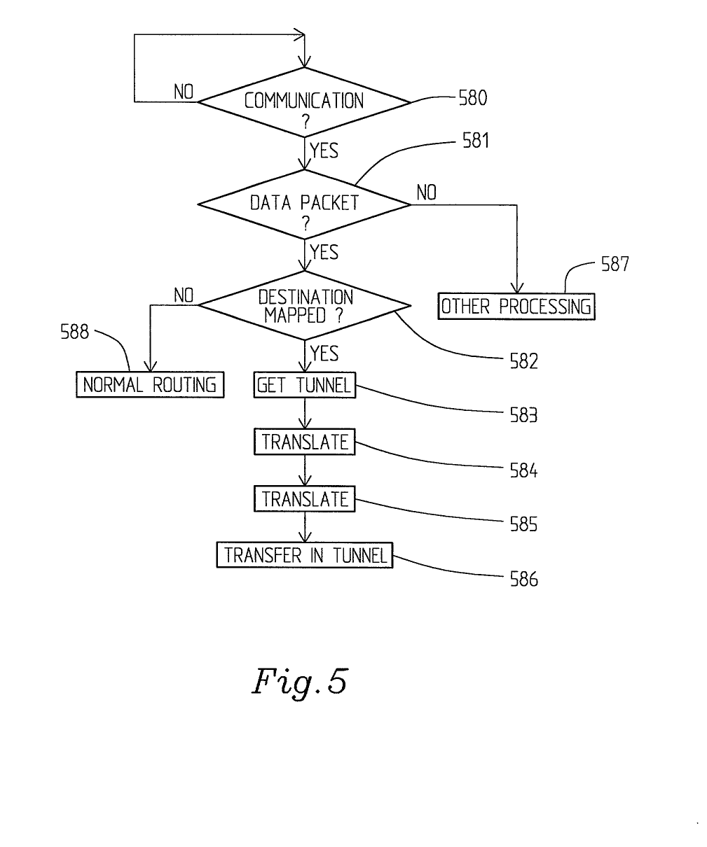

What happens next? We have opened a route interface process at the intermediate system and are now sending data packets and messages down a tunnel. FIG. 4 shows a flow chart of an example of a second domain firewall/gateway processing when receiving from a tunnel. In a first step 460 the procedure waits for some communication received from a tunnel, and returns to itself as long as there is none. However when there is some communication received from a tunnel then the procedure continues with a second step 461 after the first step 460. The second step 461 determines if the communication is a message with a mapping of a temporary random IP number with a DNS request, or not, e.g a message sent by the tenth step 349 of FIG. 3. If it determined that it is not a message with a mapping then the procedure continues with a third step 462 after the second step 461. The third step 462 determines if the communication is a data packet to be routed or not. If it is determined that it is a data packet to be routed then the procedure continues with a fourth step 463 after the third step 462. The fourth step 463 determines if there exists a mapping/table or not for the destination IP number, i.e. a temporary random IP number, of the data packet. If there exists a mapping/table for the destination IP number then the procedure continues with a fifth step 464 after the fourth step 463. The fifth step 464 determines if security control of the tunnel through which the communication came is OK and still valid. If it is determined that the security of the tunnel is satisfactory, then the procedure continues with a sixth step 465 after the fifth step 464. The sixth step 465 determines if, according to the table/map, the source IP number, e.g. the IP number of the first computer, of the data packet have allowed access to the destination IP number, i.e. the temporary random IP number, of the data packet. If it is determined that the data packet from the source IP number has access to the destination IP number then the procedure continues with a seventh step 466 after the sixth step 465. The seventh step 466 translates/re-maps the source IP number, e.g. the IP number of the first computer, to a temporary locally valid IP number, a temporary local IP number. This is done so that the packet can be routed properly in the second domain. After the seventh step 466 the procedure continues with an eighth step 467 which lookups the real local IP number of the destination, e.g. the second computer, by doing a DNS request in the second domain on the name received with the mapping to the temporary random IP number. The procedure then continues with a ninth step 468 after the eighth step 467. The ninth step 468 translates/re-maps the destination IP number, i.e. the temporary random IP number, of the data packet to the real local IP number of the destination, e.g. the second computer. Thereafter the procedure continues with a tenth step 469 after the ninth step 468. The tenth step 469 routes the data packet in the second domain to the destination, e.g. the second computer, with the real local IP number as destination and the temporary local IP number as the source.

If it was determined in the second step 461 that the communication was a map/table message then the procedure continues with an eleventh step 470 after the second step 461. The eleventh step 470 receives a mapping of a temporary random IP number with a DNS name, e.g. the second computer, of the second domain, and adds this to its mapping. If it was determined in the third step 462 that it was not a data packet to be routed that was received through the tunnel, then the procedure continues with a twelfth step 471 after the third step 462. The twelfth step 471 does other appropriate processing. If it was determined in the fifth step 464 that the security of the tunnel is not valid then the procedure could continue with a thirteenth step 472 after the fifth step 464. The thirteenth step 472 will then try to authenticate the tunnel, and then return and continue with the fifth step. If it was determined in the fourth step 463 that there does not exist a mapping/table or if it was determined in the sixth step 465 that the source IP number is not allowed access to the destination IP number, then the procedure continues with a fourteenth step 473 after either the fourth step 463 or the sixth step 465. The fourteenth will reject request, and not route the data packet, the “destination is unknown”. Preferably security will also be alerted of an attempted breach of security.

As mentioned, packets must be able to be sent back to the original requester. FIG. 5 shows a flow chart of an example of firewall/gateway processing when transferring a data packet from a second computer to a first computer. In a first step 580 it is checked if there is any communication from within the second computer network, and if not then just return to itself. If there is communication from within the second computer network, then the procedure continues with a second step 581 after the first step 580. The second step 581 determines if it is a data packet that should be routed. If it is a data packet to be routed then the procedure continues with a third step 582 after the second step 581. The third step 582 determines if the destination IP number of the data packet is equal to any valid temporary local IP number. If the destination IP number is matched then the procedure continues with a fourth step 583 after the third step 582. The fourth step retrieves the mapping/table that corresponds to the matched temporary local IP number to thereby find out where, which tunnel, to route the data package. After the fourth step 583 the procedure continues with a fifth step 584 which translates (re-maps) the source IP number, the IP number of the second computer, of the data packet to the temporary random IP number according to table (map). After the fifth step 584 the procedure continues with a sixth step 585 which translates (re-maps) the destination IP number, the temporary local IP number, of the data packet to the IP number of the first computer according to the table (map). Thereafter in a seventh step 586 after the sixth step 585 the data packet is transferred in an appropriate tunnel according to the table (map). If it was determined in the second step 581 that it is not a data packet that is to be routed then the procedure continues with an eighth step 587 after the second step 581 and does some other processing. If it was determined in the third step 582 that the destination IP number of the data packet is not equal to any valid temporary local IP number then the procedure continues with a ninth step 588 after the third step 582 and does a normal routing of the data packet.

The present invention can be put into apparatus-form either as pure hardware, as pure software or as a combination of both hardware and software. If the method according to the invention is realized in the form of software, it can be completely independent or it can be one part of a larger program. The software can suitably be located in a general-purpose computer or in a dedicated computer.

As a summary, the invention can basically be described as a method of accessing one or more hosts within a private network by means of a route interface process.

The invention is not limited to the embodiments described above but may be varied within the scope of the appended patent claims.

FIG. 1 a diagram of communication situation to which the invention is suitable,

100 open or private first domain

101 user/requestor, a first computer,

103 a first computer network, can comprise several computer networks,

105 gateway/firewall between the first computer network and a third computer network,

110 internet, the third network, will most likely comprise many networks

120 private second domain,

122 a second computer, a destination,

124 a second computer network, can comprise several networks,

126 a firewall/gateway between the second computer network and the third computer network.

FIG. 2 a diagram of an implementation of the invention,

200 open or private first domain,

201 user/requestor, a first computer, a source,

203 a first computer network, can comprise several computer networks,

205 gateway/firewall between the first computer network and a third computer network,

210 internet, the third computer network, will most likely comprise many networks,

220 private second domain,

222 a second computer, a destination,

224 a second computer network, can comprise several networks, to which the second computer is connected,

226 a firewall/gateway between the third computer network and the second computer network, the second computer,

230 an intermediate system between the third computer network and the first computer, the source,

231 a tunnel from the intermediate system to the firewall.

FIG. 3 flow chart of an example of intermediate system processing,

340 configure tunnels and generate tables/mappings

341 from 340: authentication of tunnel(s) and of users/requesters, for example from which source IP number(s), e.g. the first computer, when, and to which domains,

342 from 341 or no from itself: any communication ?

343 yes from 342: is it a DNS request ?

344 yes from 343: is it from a configured user, e.g. the first computer ?

345 yes from 344: try to match domains, in the configured user's table, with the domain of the DNS request,

346 from 345: is there a match,

347 yes from 346: get map/table and also generate a temporary IP number, a temporary random IP number, which is a valid IP number in view of the place of the intermediate system,

348 from 347: map the temporary IP number to a tunnel according to the retrieved map/table,

349 from 348: send message through tunnel with mapping of temporary random IP number with the DNS request,

350 from 349: return temporary random IP number to requester, e.g. the first computer, in answer to the DNS request,

351 no from 343: is it a data packet ?

352 yes from 351: does destination IP number of the data packet match with any temporary random IP number which is mapped with the source IP number of the data packet,

353 yes from 352: send data packet in a tunnel according to mapping/table entry,

354 no from 351: other processing,

355 no from 352: normal routing of data packet,

366 no from 344 or no from 346: do a normal DNS request processing.

FIG. 4 flow chart of an example of firewall processing when receiving from a tunnel,

460 no from itself: communication received from a tunnel?

461 yes from 460: is the communication a map/table message?

462 no from 461: is the communication a data packet to be routed?

463 yes from 462: does there exist a mapping/table for the destination IP number, i.e. a temporary random IP number, of the data packet?

464 yes from 463 or from 472: security control of tunnel, through which the communication came, is it OK, still valid ?

465 yes from 464: does, according to the table/map, the source IP number, e.g. the IP number of the first computer, of the data packet have allowed access to the destination IP number, i.e. the temporary random IP number, of the data packet ?

466 yes from 465: translate/remap source IP number, e.g. the IP number of first computer, to a temporary locally valid IP number, a temporary local IP number,

467 from 466: lookup of real local IP number of destination, e.g. the second computer, by DNS in the second domain,

468 from 467: translate/remap destination IP number, i.e. the temporary random IP number, of the data packet to the real local IP number of the destination, e.g. the second computer,

469 from 468: route the data packet in the second domain to the destination, e.g. the second computer, with the real local IP number as destination and the temporary local IP number as the source,

470 yes from 461: receive a mapping of a temporary random IP number with a DNS name, e.g. the second computer, of the second domain,

471 no from 462: do other processing,

472 no from 464: authenticate tunnel,

473 no from 463 or no from 465: reject request, do not route data packet, “destination unknown”, alarm security of an attempted break in.

FIG. 5 flow chart of an example of firewall processing when transferring a data packet from a second computer to a first computer,

580 no from itself: communication from within the second computer network ?

581 yes from 580: is it a data packet that should be routed ?

582 yes from 581: is the destination IP number of the data packet equal any valid temporary local IP number ?

583 yes from 582: get mapping/table to find out where, which tunnel, to route the data package,

584 from 583: translate (remap) the source IP number, the IP number of the second computer, of the data packet to temporary random IP number according to table (map),

585 from 584: translate (remap) the destination IP number, the temporary local IP number, of the data packet to the IP number of the first computer according to the table (map),

586 from 585: transfer data packet in appropriate tunnel according to table (map)

587 no from 581: other processing,

588 no from 582: normal routing.

What is claimed is:

1. A method of establishing a connection between a first computer of a first computer network and a resource of a second computer network via a third network, along a route through an intermediate system having an interface to the first computer network, and through a gateway intervening between the second computer network and the third network, the resource belonging to the domain of the gateway wherein the method comprises the following steps:
configuring the intermediate system with a tunnel from the intermediate system to the gateway;
mapping the tunnel with a requester and a domain name of the gateway;
the requester issuing a request for a connection from the first computer to the resource by specifying a name of the resource;
receiving the request at the intermediate system via the interface;
using a rule for matching the name of the resource with the gateway;
mapping the name of the resource to the tunnel;
returning a temporary IP number to the first computer in answer to the request;
mapping the temporary IP number to the name of the resource;
the gateway administrating the handling of data packets such that data packets addressed by the first computer to the temporary IP number, arriving through the tunnel, are routed to the resource;
the gateway administrating the handling of data packets such that data packets arriving from the resource destined to the first computer, are routed through the tunnel to the first computer via the intermediate system.

2. The method according to claim 1, wherein the method further comprises the step of:
transmitting a message with the mapping of the temporary IP number to the gateway by means of the tunnel.

3. The method according to claim 1, wherein the step of the gateway administrating the handling of data packets such that data packets addressed by the first computer to the temporary IP number, arriving through the tunnel, are routed to the resource, comprises the substep of:
directing the intermediate system to translate source addresses of data packets addressed to the temporary IP number to be sent through the tunnel.

4. The method according to claim 1, wherein the step of the gateway administrating the handling of data packets such that data packets addressed by the first computer to the temporary IP number, arriving through the tunnel, are routed to the resource, comprises the substep of:
directing the intermediate system to translate destination addresses of data packets addressed to the temporary IP number to be sent through the tunnel, by means of at least a partial DNS function in the intermediate system.

5. The method according to claim 1, wherein the step of the gateway administrating the handling of data packets such that data packets addressed by the first computer to the temporary IP number, arriving through the tunnel, are routed to the resource, comprises the substep of:
the gateway translating source addresses of data packets arriving through the tunnel addressed to the temporary IP number and routing these data packets to the resource.

6. The method according to claim 1, wherein the step of the gateway administrating the handling of data packets such that data packets addressed by the first computer to the temporary IP number, arriving through the tunnel, are routed to the resource, comprises the substep of:
the gateway translating destination addresses of data packets arriving through the tunnel addressed to the temporary IP number and routing these data packets to the resource.

7. The method according to claims 1, wherein the step of the gateway administrating the handling of data packets such that data packets arriving from the resource destined to the first computer, are routed through the tunnel to the first computer via the intermediate system, comprises the substep of:
the gateway translating source and destination addresses of data packets arriving from the resource destined to the first computer, and routing these data packets through the tunnel to the first computer via the intermediate system.

8. The method according to claim 1, wherein the step of the gateway administrating the handling of data packets such that data packets arriving from the resource destined to the first computer, are routed through the tunnel to the first computer via the intermediate system, comprises the substep of:
directing the intermediate system to translate source and destination addresses of data packets arriving from the resource via the tunnel destined to the first computer.

9. The method according to claim 1, wherein the third network is a telecommunications network.

10. The method according to claim 1, wherein the third network is the Internet.

11. The method according to claim 1, wherein the rule for matching the name of the resource with the gateway is based on a mapping.

12. The method according to claim 1, wherein the rule for matching the name of the resource with the gateway is based on a list of hosts.

13. The method according to claim 1, wherein the rule for matching the name of the resource with the gateway is based on a regular or wildcard expression.

14. The method according to claim 1, wherein the rule for matching the name of the resource with the gateway is based on matching a domain name of the name of the resource with the domain name of the gateway.

15. The method according to claim 1, wherein the method further comprises the step of:
authenticating the requester at the first computer for access to the tunnel.

16. The method according to claim 1, wherein the name of the resource corresponds to a second computer within the second computer network, the second computer belonging to the domain of the gateway and comprising the resource.

17. The method according to claim 16, wherein the gateway administrating the handling of data packets such that data packets addressed by the first computer to the temporary IP number, arriving through the tunnel, are routed to the resource residing on the second computer.

18. The method according to claim 16, wherein the gateway administrating the handling of data packets such that data packets addressed by the first computer to the temporary IP number, arriving through the tunnel, are routed to the resource, the resource residing on a proxy of the second computer.

19. The method according to claim 18, wherein the proxy to which the gateway routes data packets addressed by the first computer to the temporary IP number, is in dependence on an identity of the requester.

20. A device arranged to establish a connection between a first computer of a first computer network and a resource of a second computer network via a third network, along a route through the device having an interface to the first computer network, and through a gateway intervening between the second computer network and the third network, the resource belonging to the domain of the gateway wherein the device comprises:
means arranged to configure a tunnel from the device to the gateway,
means arranged to map the tunnel with a requester and a domain name of the gateway,
means arranged to receive a request, issued by the requester, via the interface for a connection from the first computer to the resource by specifying a name of the resource,
means arranged to use a rule for matching the name of the resource with the gateway,
means arranged to map the name of the resource to the tunnel,
means arranged to return a temporary IP number to the first computer in answer to the request,
means arranged to map the temporary IP number to the name of the resource,
means arranged to cooperate with the gateway administrating the handling of data packets such that data packets addressed by the first computer to the temporary IP number, arriving through the tunnel at the gateway, are routed to the resource,
means arranged to cooperate with the gateway administrating the handling of data packets such that data packets arriving from the resource destined to the first computer, are at the gateway routed through the tunnel to the first computer via the device.
